(19) United States
(12) Patent Application Publication
(10) Pub. No.: US 2016/0171635 A1
(43) Pub. Date: Jun. 16, 2016

(54) Automated Contract Terms Negotiating System and Method

(71) Applicant: Thomas A. Senzee, San Diego, CA (US)

(72) Inventor: Thomas A. Senzee, San Diego, CA (US)

(21) Appl. No.: 14/570,892

(22) Filed: Dec. 15, 2014

(51) Int. Cl. G06Q 50/18; G06Q 10/10

(52) U.S. Cl. CPC G06Q 50/188; G06Q 10/10

(57) ABSTRACT

Systems and methods for identifying and displaying to a user problematic terms presented by a program or website, and presenting alternative options to the user. Various embodiments can recognize cooperating websites and computer programs, and present the user with an option to negotiate some or all of the presented terms.

### BACKGROUND

(1) Technical Field

This invention relates to systems and methods for automated negotiation of contract terms presented in a computer environment.

(2) Background

Many computer programs and Internet websites present contract or license terms (collectively, “terms”) to a user before allowing full use of the corresponding program or website. In many—if not most—cases, the user's only choices are to accept the terms presented “as is”, or reject the terms and thereby be excluded from full use of the corresponding program or website. Thus, most such terms are not negotiable by the user. In addition, particularly problematic terms are often buried within a lengthy document that must be scrolled through in order to read the entirety of the document.

Accordingly, there is a need to identify and display to a user problematic terms presented by a program or website, and provide the user with alternative options for such terms.

### SUMMARY OF THE INVENTION

The present disclosure teaches various systems and methods for identifying and displaying to a user problematic terms presented by a program or website, and presenting alternative options to the user. For example, a user may attempt to log into a website forum. Upon initially doing so, the user may be presented with a set of legal terms to accept or reject. Various embodiments of the invention can recognize cooperating websites and present the user with an option to negotiate some or all of the presented terms. As another example, when installing a computer program, a user may be presented with a dialog that recites legal terms. Again, various embodiments of the invention can recognize cooperating computer programs and present the user with an option to negotiate some or all of the presented terms.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1A and FIG. 1B are a flow chart showing a first embodiment of the invention.

FIG. 2 is an image of a computer program dialog box showing identified terms.

FIG. 3A and FIG. 3B are a flow chart showing a second embodiment of the invention.

FIG. 4 is an image of a computer program dialog box showing presentation of alternative terms provided by an embodiment of the invention.

Like reference numbers and designations in the various drawings indicate like elements.

### DETAILED DESCRIPTION OF THE INVENTION

The present disclosure teaches various systems and methods for identifying and displaying to a user problematic terms presented by a program or website, and presenting alternative options to the user. For example, a user may attempt to log into a website forum. Upon initially doing so, the user may be presented with a set of legal terms to accept or reject. Various embodiments of the invention can recognize cooperating websites and present the user with an option to negotiate some or all of the presented terms. As another example, when installing a computer program, a user may be presented with a dialog that recites legal terms. Again, various embodiments of the invention can recognize cooperating computer programs and present the user with an option to negotiate some or all of the presented terms.

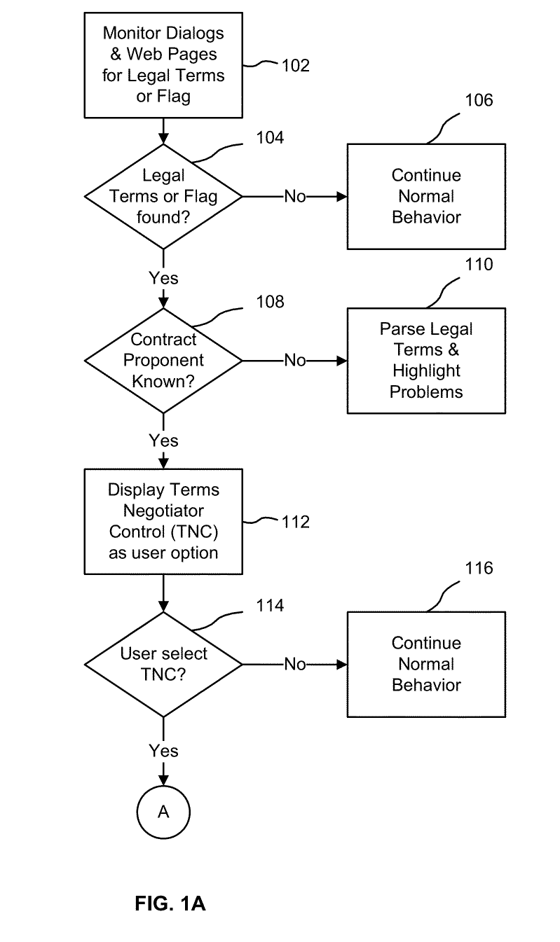

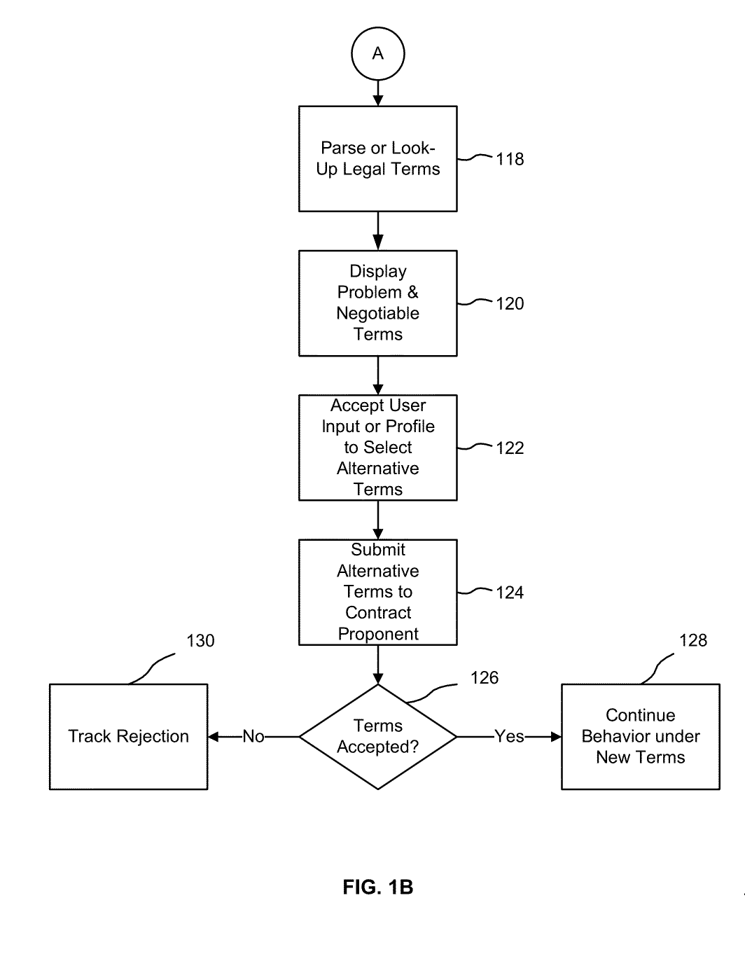

FIG. 1A and FIG. 1B are a flow chart showing a first embodiment of the invention. A computer program—the “terms negotiator program”—running in the background on a user's computer system monitors dialogs or text presented by other computer programs and/or by website pages in a browser program (e.g., Internet Explorer or Safari) for the presence of an indicia that terms are present. The indicia may be the existence of detected textual terms, or a “flag” code indicating that the other computer program and/or website is compatible with the terms negotiator program (STEP 102).

In some embodiments, the terms negotiator program can monitor presented dialogs or webpage text (collectively, “presented text”) for terms by using well-known data scraping techniques, including screen scraping, and can search or parse the scraped data for keywords or phrases common to legal documents. For example, scraped text may be searched for the presence of such contract terms as “license”, “warranty”, “choice of law”, and the like. As an alternative for webpages, some of the concepts of the invention can be embodied in a browser that continuously monitors webpages for the existence of terms in presented text.

For third-party computer programs or websites that have chosen to cooperate with the terms negotiator program, such computer programs or websites may simply present a flag code (such as a binary number or special symbol) in presented text that is recognized by the terms negotiator program as an indicia of compatibility.

If no terms are found in the scraped data and no flag is present (STEP 104), then the user's computer system may continue its normal behavior, such as installing or running a computer program or displaying a website page (STEP 106). However, if terms are found in the scraped data or if a flag is present (STEP 104), then a determination is made by the terms negotiator program as to whether the contract proponent is known (STEP 108). For example, if a flag code is present, the flag code itself may serve as a unique identifier of the contract proponent, which may be compared to a database of cooperating entities. As another example, the scraped data may include the name of the contract proponent, which also may be compared to a database of cooperating entities. As yet another example, the terms negotiator program may parse the URL of an active webpage to determine the identity of the contract proponent, particularly since such URLs often contain the name of the company or other entity generating the webpage.

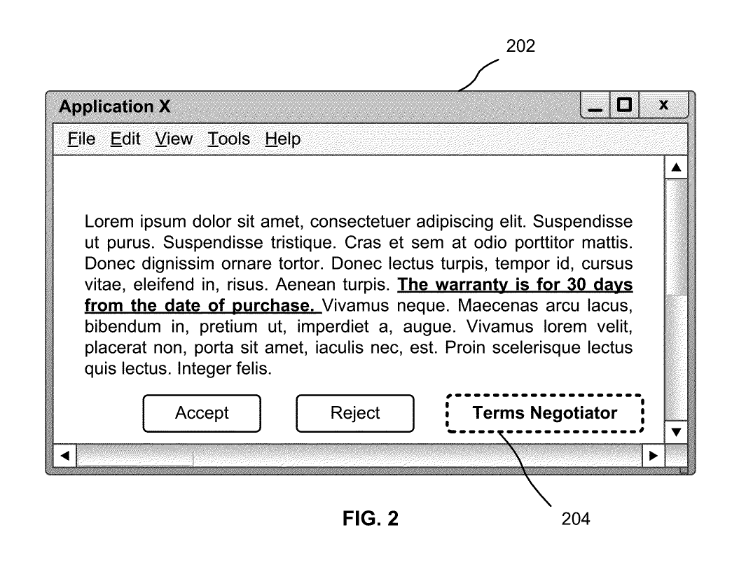

If the contract proponent is not known (STEP 108), there may be no opportunity to conduct a negotiation with that entity. In such a case, the terms negotiator program may analyze the presented terms for problematic terms, such as by parsing the terms, and highlight or flagging problems with such terms (STEP 110). For example, FIG. 2 is an image of a computer program dialog box 202 showing identified terms. In this example, a block of “legalese” (shown mostly as placeholder text) presented by a third-party computer program has been parsed and determined to contain the phrase “The warranty is for 30 days from the date of purchase”, which has been emphasized (through bolding and underlining in the illustrated example) by the terms negotiator program. Accordingly, the user is warned of potentially problematic terms automatically without having to read through pages of text. In other embodiments, the terms negotiator program may identify and flag problematic terms and collect those terms into a list for presentation to the user; again, the user is warned of potentially problematic terms automatically without having to read through pages of text. Thus, even if an active negotiation cannot be conducted because the contract proponent is not a participant in the terms negotiator system, the user is at least aided in assessing the acceptability of terms in presented text.

If the contract proponent is known (STEP 108), the terms negotiator program may display a terms negotiator control (TNC) 204 (STEP 112), as shown in FIG. 2. The TNC may be implemented as an overlay to an existing dialog box or be injected as a new object or element in the presented text. At this point, the user may “Accept” or “Reject” the presented terms using the original control buttons, or select the newly displayed TNC as an option (STEP 114). If the user does not select the TNC, then the user's computer system may continue its normal behavior based on other selections or actions of the user (STEP 116). As should be clear, other methods of displaying a control may be used in place of the TNC 204, such as separate pop-up dialogs, and the user may select the TNC by various means, including mouse clicks, finger presses, voice commands, hand or finger gestures or swipes, and the like.

If the user selects the TNC (STEP 114), then the terms negotiator program may analyze the terms for problems (as in STEP 110) by parsing the presented terms or looking up pre-determined problems with the presented terms (STEP 118 in FIG. 1B). For example, if it is determined that the presented terms are for a specific contract, the terms negotiator program can simply look up a previously reviewed copy of the contract. As another example, if the contract proponent is in a relationship with the vendor of the terms negotiator program, then the terms negotiator program may query the contract proponent in real-time as to what terms in the proffered language are negotiable (for example, by submitting a query to a database of terms maintained by the contract proponent). If the contract proponent is not in a relationship with the vendor of the terms negotiator program, then the terms negotiator program may offer to the user an option to send a notification (e.g., an email) to the contract proponent requesting that the contract proponent enter into such a relationship with the vendor.

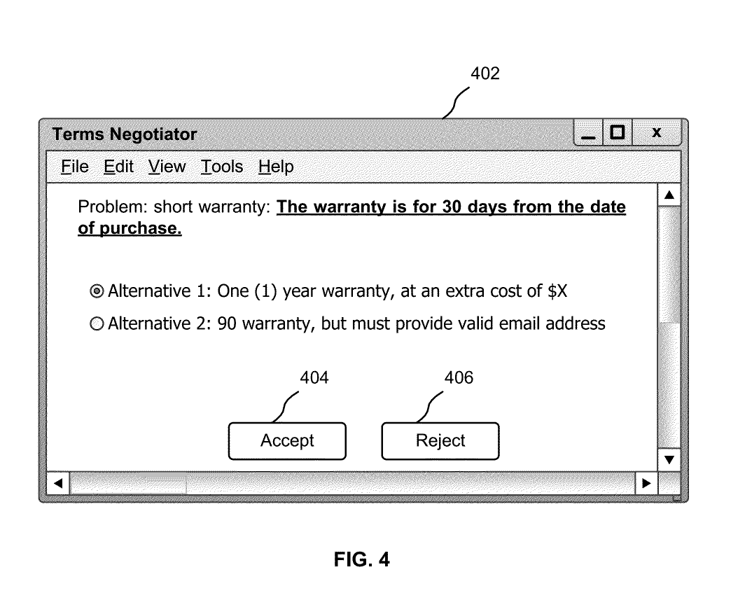

In any case, the problem terms are displayed to the user, for example, in the form of highlighted version of the original text containing the terms, or as a list of problematic terms (STEP 120). In addition, the terms negotiator program may indicate which of the terms are negotiable with the contract proponent (STEP 120). For example, FIG. 4 is an image of a computer program dialog box 402 showing presentation of alternative terms provided by an embodiment of the invention. In the illustrated example, the terms negotiator program has identified that the presented terms include a short warranty (30 days). In this example, the terms negotiator program has identified the contract proponent as a cooperating entity that is willing to negotiate some terms. In this example, the terms negotiator program has indicated two alternative terms that would be acceptable to the contract proponent. Alternative 1 provides for a one-year warranty, but at an extra cost of $X. Alternative 2 provides for a 90 day warranty, but the user must provide a valid email address (for example, so that the contract proponent can send advertisements). If either alternative is acceptable, the user will select one of the alternatives and select the “Accept” control button 404; otherwise, the user will select the “Reject” control button 406 (STEP 122).

In some embodiments, the user may create a profile which records the user's preferences as to contract terms. For example, a user may indicate in a profile established with a vendor of the terms negotiator program that the minimum warranty term acceptable to that user is 90 days. Accordingly, the terms negotiator program need not require direct user input with respect to displayed and negotiable terms, but may instead apply the user's profile to select alternative terms that meet the user's profile criteria (STEP 122). The terms negotiator program may then either automatically submit the alternative terms to the original contract proponent, or await final confirmation by the user of the alternative terms selected according to the user's profile. A user profile may be created or updated by the user through a locally installed version of the terms negotiator program, or by signing on to a website of the vendor of the terms negotiator program. For example, the terms negotiator program or a corresponding website may present a set of questions to a user about the user's preferences regarding such things as warranty term, privacy restrictions or permissions, dispute resolution, email contact permissions, billing terms, etc.

Once alternative terms are selected by the user, either by direct input or by application of the user's profile, the alternative terms are submitted to the original contract proponent (STEP 124). If the contract proponent accepts the alternative terms (STEP 126), the user may then continue using the program or website subject to the new alternative terms (STEP 128). The contract proponent may have previously agreed to substitution of selected alternative terms for the originally presented terms. In addition, if the contract proponent has not previously agreed to alternative terms, the user may continue using the program or website if the contract proponent accepts the proposed alternative terms. If the contract proponent does not accept the terms (STEP 126), the terms negotiator program may record the rejection in order to keep track of users who would like the contract proponent to cooperate with the terms negotiator program. Such recorded information, sent back to the vendor of the terms negotiator program, would enable the vendor to undertake a prospective partner data analysis. For example, the collection of recorded information about requests to non-cooperating entities may be used to persuade such entities to cooperate with the vendor of the terms negotiator program (e.g., “last quarter, Company X, 2 million terms negotiator program customers attempted to ping your servers to negotiate with you on terms and conditions”).

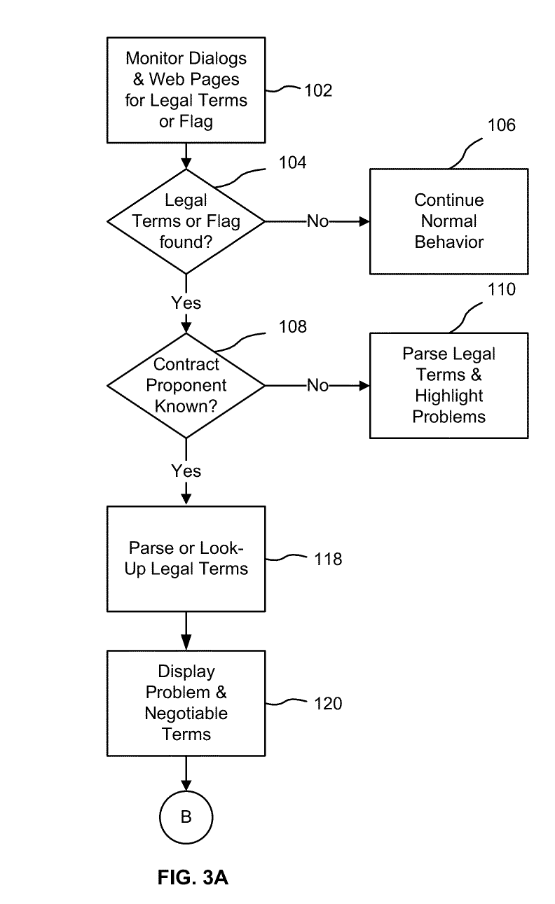

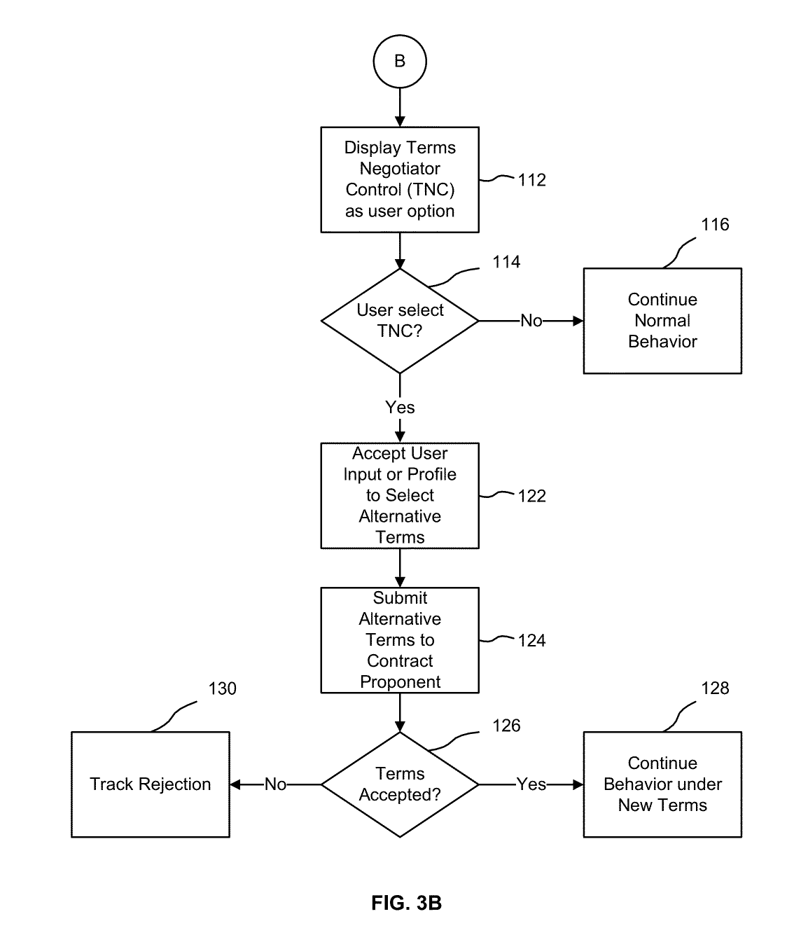

The steps described with respect to FIG. 1A and FIG. 1B may be performed in a different order. For example, FIG. 3A and FIG. 3B are a flow chart showing a second embodiment of the invention. Each of the steps shown in FIG. 1A and FIG. 1B are shown, but in a different order, showing than an implementer of the terms negotiator program has flexibility with respect to how the program interacts with a user.

Accordingly, by automatically identifying problematic terms in presented text, the terms negotiator program alerts a user without the user having to wade through a lengthy text. Further, when interacting with a cooperative contract proponent, a user can negotiate alternative terms. For example, a user may respond to terms for a downloaded program by indicating that the user does not agree to receive “informative” emails, or to a condition requiring an unknown mediator to handle any disagreements, or to a provision allowing a vendor to bill the user's credit card after a trial period ends. In still other embodiments, a user may choose from prepackaged suites of negotiated terms and conditions that can be applied to almost any type of user agreement.

The ability of the terms negotiator program to present alternative terms to a user that are known to be acceptable to a cooperative contract proponent is a benefit to such cooperative contract proponents, in that they may often be willing to accept a variety of terms but have lacked a suitable mechanism for presenting such alternatives; accordingly, they have simply used a “one-size-fits-all” approach to terms. Embodiments of the present invention provide functionality that allows such contract proponents to readily indicate their willingness to accept one or more alternative terms for various provisions. Thus, by compromising to some degree on terms, a cooperative contract proponent attains a satisfied customer rather than losing business over some minor aspect of what are often over-engineered terms and conditions.

In some embodiments, the terms negotiator program may be locally installed on the user's computer, tablet, smartphone, or the like; in such embodiments, the terms negotiator program can monitor both website pages and local computer programs. In other embodiments, the terms negotiator program may reside upon a server controlled by the user's Internet service provider (ISP); in such embodiments, the terms negotiator program may only be able to monitor website pages. In this latter case, the ISP can monitor and parse webpages passing through the ISP for multiple users, and dynamically alter such webpages so as to highlight problematic terms and present a terms negotiator control (i.e., a “man in the middle” model). In still other embodiments, a cooperative contract proponent may build a terms negotiator control into dialog boxes or other text presented to a user.

One aspect of the invention includes a method for negotiating terms presented on a computer by a contract proponent, including the steps of:
STEP 1: monitoring text presented on the computer from the contract proponent for an indicia of presented terms;
STEP 2: analyzing the presented terms for problematic terms;
STEP 3: displaying to the user problematic terms from the presented terms;
STEP 4: providing a control to the user to enable selection of alternative terms to one or more of the displayed problematic terms;
STEP 5: accepting user input selecting at least one alternative term; and
STEP 6: submitting each selected alternative term to the contract proponent.

Another aspect of the invention includes a method for negotiating terms presented on a computer by a contract proponent, including the steps of:
STEP 1: monitoring text presented on the computer from the contract proponent for an indicia of presented terms;
STEP 2: providing a control to the user to enable selection of alternative terms;
STEP 3: analyzing the presented terms for problematic terms;
STEP 4: displaying to the user problematic terms from the presented terms;
STEP 5: accepting user input selecting at least one alternative term to the displayed problematic terms; and
STEP 6: submitting each selected alternative term to the contract proponent.

Yet another aspect of the invention is one or more computer programs embodied on a non-transitory computer-readable medium for negotiating terms presented on a computer by a contract proponent, the one or more computer programs including instructions for causing a computer to perform the steps of the methods described above. A still further aspect of the invention is a non-transitory computer-readable medium encoding program instructions operable to cause one or more machines to perform operations implementing the steps of the methods described above.

Programmed Embodiments

Some or all aspects of the invention may be implemented in hardware or software, or a combination of both (e.g., programmable logic arrays). Unless otherwise specified, the algorithms included as part of the invention are not inherently related to any particular computer or other apparatus. In particular, various general purpose computing machines may be used with programs written in accordance with the teachings herein, or it may be more convenient to use a special purpose computer or special-purpose hardware (such as integrated circuits) to perform particular functions. Thus, the invention may be implemented in one or more computer programs executing on one or more programmed or programmable computer systems (which may be of various architectures, such as distributed, client/server, or grid) each comprising at least one processor, at least one data storage system (which may include volatile and non-volatile memory and/or storage elements), at least one input device or port, and at least one output device or port. Program code is applied to input data to perform the functions described herein and generate output information. The output information is applied to one or more output devices, in known fashion.

Each such computer program may be implemented in any desired computer language (including machine, assembly, or high level procedural, logical, or object oriented programming languages) to communicate with a computer system, and may be implemented in a distributed manner in which different parts of the computation specified by the software are performed by different computers. In any case, the language may be a compiled or interpreted language. Computer programs implementing some or all of the invention may form one or more modules of a larger program or system of programs. Some or all of the elements of the computer program can be implemented as data structures stored in a computer readable medium or other organized data conforming to a data model stored in a data repository.

Each such computer program may be stored on or downloaded to (for example, by being encoded in a propagated signal and delivered over a communication medium such as a network) a tangible, non-transitory storage media or device (e.g., solid state memory or media, or magnetic or optical media) readable by a general or special purpose programmable computer, for configuring and operating the computer when the storage media or device is read by the computer system to perform the procedures described herein. The inventive system may also be considered to be implemented as a computer-readable storage medium, configured with a computer program, where the storage medium so configured causes a computer system to operate in a specific and predefined manner to perform the functions described herein.

A number of embodiments of the invention have been described. It is to be understood that various modifications may be made without departing from the spirit and scope of the invention. For example, some of the steps described above may be order independent, and thus can be performed in an order different from that described. Various activities described with respect to the embodiments identified above can be executed in repetitive, serial, or parallel fashion. It is to be understood that the foregoing description is intended to illustrate and not to limit the scope of the invention, which is defined by the scope of the following claims, and that other embodiments are within the scope of the claims.

What is claimed is:

1. A method for negotiating terms presented on a computer by a contract proponent, including:
(a) monitoring text presented on the computer from the contract proponent for an indicia of presented terms;
(b) analyzing the presented terms for problematic terms;
(c) displaying to the user problematic terms from the presented terms;
(d) providing a control to the user to enable selection of alternative terms to one or more of the displayed problematic terms;
(e) accepting user input selecting at least one alternative term; and
(f) submitting each selected alternative term to the contract proponent.

2. The method of claim 1, wherein accepting user input selecting at least one alternative term includes applying a user profile of contract preferences to automatically pre-select at least one alternative term.

3. The method of claim 1, further including:
(a) recording rejections by the contract proponent of any submitted selected alternative terms; and
(b) collecting such recorded rejection for prospective partner data analysis.

4. A method for negotiating terms presented on a computer by a contract proponent, including:
(a) monitoring text presented on the computer from the contract proponent for an indicia of presented terms;
(b) providing a control to the user to enable selection of alternative terms;
(c) analyzing the presented terms for problematic terms;
(d) displaying to the user problematic terms from the presented terms;
(e) accepting user input selecting at least one alternative term to the displayed problematic terms; and
(f) submitting each selected alternative term to the contract proponent.

5. The method of claim 4, wherein accepting user input selecting at least one alternative term includes applying a user profile of contract preferences to automatically pre-select at least one alternative term.

6. The method of claim 4, further including:
(a) recording rejections by the contract proponent of any submitted selected alternative terms; and
(b) collecting such recorded rejection for prospective partner data analysis.

7. A computer program embodied on a non-transitory computer-readable medium for negotiating terms presented on a computer by a contract proponent, the computer program including instructions for causing a computer to:
(a) monitor text presented on the computer from the contract proponent for an indicia of presented terms;
(b) analyze the presented terms for problematic terms;
(c) display to the user problematic terms from the presented terms;
(d) provide a control to the user to enable selection of alternative terms to one or more of the displayed problematic terms;
(e) accept user input selecting at least one alternative term; and
(f) submit each selected alternative term to the contract proponent.

8. The computer program of claim 7, wherein the instructions for causing a computer to accept user input selecting at least one alternative term further include instructions for causing a computer to apply a user profile of contract preferences to automatically pre-select at least one alternative term.

9. The computer program of claim 7, further including instructions for causing a computer to:
(a) record rejections by the contract proponent of any submitted selected alternative terms; and
(b) collect such recorded rejection for prospective partner data analysis.

10. A computer program embodied on a non-transitory computer-readable medium for negotiating terms presented on a computer by a contract proponent, the computer program including instructions for causing a computer to:
(a) monitor text presented on the computer from the contract proponent for an indicia of presented terms;
(b) provide a control to the user to enable selection of alternative terms;
(c) analyze the presented terms for problematic terms;
(d) display to the user problematic terms from the presented terms;
(e) accept user input selecting at least one alternative term to the displayed problematic terms; and
(f) submit each selected alternative term to the contract proponent.

11. The computer program of claim 10, wherein the instructions for causing a computer to accept user input selecting at least one alternative term further include instructions for causing a computer to apply a user profile of contract preferences to automatically pre-select at least one alternative term.

12. The computer program of claim 10, further including instructions for causing a computer to:
(a) record rejections by the contract proponent of any submitted selected alternative terms; and
(b) collect such recorded rejection for prospective partner data analysis.
